(19) United States
(12) Patent Application Publication
(10) Pub. No.: US 2012/0114947 A1
(43) Pub. Date: May 10, 2012

(54) POLYMER-FUNCTIONALIZED CARBON NANOTUBE, PROCESS FOR ITS PRODUCTION AND USE

(76) Inventors: Werner Jenninger, Koln (DE); Joachim Wagner, Koln (DE); Helmut Meyer, Odenthal (DE); Stephanie Vogel, Langenfeld (DE); Stefan Spange, Orlamunde (DE); Doreen Piasta, Chemnitz (DE); Bernd Grünler, Zeulenroda (DE); Andreas Heft, Gera (DE); Frank Simon, Dresden (DE)

(21) Appl. No.: 13/262,717

(22) PCT Filed: Mar. 26, 2010
(86) PCT No.: PCT/EP2010/001922

§ 371 Date: Jan. 20, 2012

(30) Foreign Application Priority Data
Apr. 8, 2009 (EP) 09005138.4

(51) Int. Cl. H01B 1/24; C08F 12/28; B32B 9/04; C08L 39/02; B82Y 30/00; B82B 1/00; B82B 3/00

(52) U.S. Cl. 428/407; 252/511; 525/328.2; 524/555; 977/746; 977/847; 977/902

(57) ABSTRACT

The invention describes novel polymer-functionalized carbon nanotubes. These comprise a carbon nanotube, a first polymer that is adsorbed on the outer surface of a carbon nanotube and comprises amino groups, and a second polymer covalently bonded to the first polymer. The bond between the second polymer and the first polymer is formed by the reaction of amino groups from the first polymer with groups from the second polymer that are reactive with respect to amino groups. The invention further relates to a method for the production thereof, wherein carbon nanotubes are provided in an aqueous solution of a first polymer comprising amino groups and then a solution of a second polymer comprising groups that are reactive with respect to amino groups is added. The invention also relates to the use of the carbon nanotubes in dispersions, polymers and surface coatings.

The present invention relates to a polymer-functionalized carbon nanotube comprising a carbon nanotube, a first polymer containing amino groups which is adsorbed on the outer surface of the carbon nanotube, and a second polymer covalently bonded to the first polymer. It further relates to a process for the production of such a polymer-functionalized carbon nanotube, to a dispersion comprising these nanotubes, to polymers comprising these nanotubes and to surface coatings comprising these nanotubes.

Carbon nanotubes (CNT) are interesting materials for a multiplicity of applications in low-tech and high-tech sectors. Of importance for many applications are the separation of carbon nanotubes and the maintenance of their dispersion in suspensions or polymer matrices.

A large number of studies are known which describe surface reactions on carbon nanotubes. Oxidizing processes are often used to reactively bond keto and carboxyl groups to the surface of the nanotubes, thereby creating a sufficient surface polarity and surface reactivity for possible subsequent reactions. However, a disadvantage of this functionalization is that the delocalized π-electron system of the nanotubes can be interrupted by the oxidation, which may result in the loss of desired properties. An alternative is to sheathe the nanotubes with polymers.

EP 1 988 390 A2 discloses the design and synthesis of a matrix nanocomposite with amino carbon nanotubes as a functionalized sensory layer for detecting carbon dioxide by the recognition of sound waves, e.g. acoustic surface waves or structure-borne sound waves. These sensory materials contain an amino carbon nanotube (single-walled or multiwalled) and a polymer or other compounds which are sensitive to carbon dioxide in the sound wave-based sensor. The sensitivity of the matrix consisting of the amino carbon nanotubes and a polymer or other compounds is assured by the presence of amino groups, which can react reversibly with carbon dioxide at room temperature to form carbamates. Polymers with which the amino carbon nanotubes can form a matrix are, inter alia, polyvinylamine and polyallylamine.

WO 2002/16257 A2 discloses polymer-coated and polymer-sheathed single-walled carbon nanotubes. Said publication further relates to small strands of polymer-coated and polymer-sheathed single-walled carbon nanotubes and materials containing these nanotubes. Such a polymer modification eliminates the van der Waals forces of attraction between individual single-walled carbon nanotubes and small strands of single-walled carbon nanotubes. This makes it possible to keep these nanotubes better suspended in a solvent, even at higher concentrations. Suitable coating polymers which may be mentioned are, inter alia, polyvinyl-pyrrolidone, polystyrene sulfonate, poly(1-vinylpyrrolidone-co-vinyl acetate), poly-(1-vinylpyrrolidone-co-acrylate), poly(1-vinylpyrrolidone-co-dimethylaminoethyl methacrylate), polyvinyl sulfate, poly(sodium styrenesulfonic acid-co-maleic acid), dextran, dextran sulfate, bovine serum albumin, poly(methyl methacrylate-co-ethyl acrylate), polyvinyl alcohol, polyethylene glycol, polyallylamines and mixtures thereof.

EP 1 777 259 A1 discloses polymers reinforced with carbon nanotubes. The carbon nanotubes are brought into contact in an aqueous medium with a water-soluble salt of an amphiphilic polymer, preferably an ammonium salt of an amphiphilic polymer, thereby increasing the compatibility of the carbon nanotubes with water. The dispersion obtained is subsequently mixed with an aqueous latex of a second polymer (matrix polymer) or of one or more precursors of the second polymer (matrix polymer) and the water is then removed. The resulting product is then heated to a temperature at which the matrix polymer becomes liquid or the matrix polymer is formed from the precursors. The amphiphilic polymer is preferably present as an ammonium salt. The amphiphilic polymers do not carry any reactive groups that would be capable of reacting with the matrix polymer, but rather are fully reacted polymers; there is no second polymer covalently bonded to the first polymer. The matrix polymer is present as an aqueous latex dispersion and cannot undergo any chemical reactions with the amphiphilic polymer.

Said coating polymers all have hydrophilic properties, so the polymers coated therewith are hydrophilized on their surface. This is a disadvantage, however, for applications where the nanotubes are to be incorporated into a less hydrophilic matrix. It would be desirable to have carbon nanotubes in which the degree of hydrophilicity or hydrophobicity of the surface were adjustable.

The invention therefore proposes a polymer-functionalized carbon nanotube comprising a carbon nanotube, a first polymer containing amino groups which is adsorbed on the outer surface of the carbon nanotube, and a second polymer covalently bonded to the first polymer, the bonding of the second polymer to the first polymer being achieved by the reaction of amino groups on the first polymer with groups on the second polymer which are reactive towards amino groups.

The invention provides a polymer-functionalized carbon nanotube comprising a carbon nanotube, a coupling product of a first polymer containing amino groups with a second polymer covalently bonded to the first polymer, said coupling product being adsorbed on the outer surface of the carbon nanotube, the second polymer being bonded to the first polymer by the reaction of amino groups on the first polymer with groups on the second polymer which are reactive towards amino groups.

In terms of the invention, carbon nanotubes—also synonymously called nanotubes hereafter—comprise all single-walled or multiwalled carbon nanotubes of the cylinder, scroll or multiscroll type or with a bulbiform structure. It is preferable to use multiwalled carbon nanotubes of the cylinder, scroll or multiscroll type or mixtures thereof. It is favourable if the carbon nanotubes have a ratio of length to external diameter of ≧5, preferably of ≧100.

As distinct from the known carbon nanotubes of the scroll type with only one continuous or interrupted graphene sheet, which have already been mentioned, there also exist carbon nanotube structures consisting of several graphene sheets which are stacked together and rolled up. This is referred to as a multiscroll type. These carbon nanotubes are known to those skilled in the art and are described in DE 10 2007 044031 A1, which is fully incorporated herein by way of reference. This structure compares to the carbon nanotubes of the simple scroll type in the same way as the structure of cylindrical multiwalled carbon nanotubes (cylindrical MWNT) compares to the structure of cylindrical single-walled carbon nanotubes (cylindrical SWNT).

Advantageously, the carbon nanotubes to be used for the production of the polymer-functionalized carbon nanotubes are not covalently functionalized on their surface. This means that the nanotubes preferably do not carry on their surface any additional functional groups covalently bonded via further reaction steps. In particular, the use of oxidizing agents such as nitric acid, hydrogen peroxide, potassium permanganate and sulfuric acid, or a possible mixture of these agents, for functionalization of the nanotubes is avoided. An advantage of using non-covalently functionalized nanotubes is that the π-electron system on the surface is not disturbed, so it can interact unrestrictedly with free amino groups on the first polymer.

Provision is made for a first polymer containing amino groups to be adsorbed on the outer surface of the carbon nanotube. The adsorption is to be understood as follows: substantially no covalent bonding of the first polymer to the nanotube surface takes place, but there are physical non-covalent interactions between the nanotube and the first polymer. Examples of this are electron transfers of the free electron pair on the aminic nitrogen atom to the conjugated π-electron system of the nanotube, or else thermodynamic effects which lead to wrapping of the polymer strand around the nanotube. The first polymer can wrap around the nanotube once or several times. Another possibility is for the first polymer not to wrap around the nanotube, but simply to lie on its surface.

In terms of the present invention, “substantially no covalent bonding of the first polymer to the nanotube surface” means that preferably <30% of the molecules or preferably <20%, particularly preferably <10% of the molecules and very particularly preferably <5% of the molecules of the first polymer are bonded to the nanotube surface.

The polymer-functionalized carbon nanotube according to the invention also comprises a second polymer covalently bonded to the first polymer. The covalent bonding of the second polymer to the first is achieved by the reaction of reactive groups on the second polymer with the amino groups on the first polymer. Reactive groups on the second polymer can be e.g. acid groups, acid halides, acid anhydrides, activated carboxylic acid groups such as carboxylic acid halides, carboxylic acid methyl esters and carboxylic acid anhydrides, succinimidyl esters and also isocyanate groups, aldehyde groups, keto groups and/or epoxy groups.

By reacting a second polymer with free amino groups on the first polymer, the primary adsorbate layer of the first polymer on the carbon nanotube can be stabilized by intramolecular or intermolecular crosslinking reactions, the intramolecular crosslinkings being of prime importance here. This is in contrast to a simple functionalization of the layer of the first polymer by low-molecular reagents. In other words, the polymer-functionalized carbon nanotube according to the invention can be such that the second polymer intramolecularly crosslinks the first polymer. In that case more than one amino group on a polymer strand of the first polymer reacts with more than one group on a polymer strand of the second polymer which is reactive towards amino groups.

By choosing the second polymer, it becomes possible also to impart hydrophobic properties to an initially hydrophilic surface of the carbon nanotube. This is important if such nanotubes are to be incorporated into a polymer matrix, for example. The nanotubes can have water contact angles of e.g. 145° to 175°, preferably of 155° to 170°, as determined by the Wilhelmy plate method. For planning a rational synthesis, a common precursor can initially be used for different desired surface properties.

In one embodiment of the polymer-functionalized carbon nanotube according to the invention, the amino groups on the first polymer containing them are primary amino groups. This is particularly advantageous if the adsorption of the first polymer on to a nanotube is to take place from aqueous solution. In that case a benefit is derived from the water solubility of the polymers containing primary amino groups. Furthermore, such polymers have two reactive H atoms per aminic N atom, which enables the second polymer to undergo a wider group of bonding reactions.

In another embodiment of the polymer-functionalized carbon nanotube according to the invention, the first polymer is selected from the group comprising polyvinyl-amine, polyallylamine, polyaminosaccharides, polyethyleneimine and/or copolymers based on the aforementioned polymers, or on the monomers from which they are synthesized, with other comonomers. Said comonomers can be any monomers that copolymerize with said polymers or monomers, especially reactive vinyl monomers. The molecular weight M_{w} of these polymers can be 50,000 g/mol to 500,000 g/mol, preferably 200,000 g/mol to 400,000 g/mol. Particular preference is afforded to a polyvinylamine with a molecular weight M_{w} of 330,000 g/mol to 350,000 g/mol and a degree of hydrolysis of ≧90%.

In another embodiment of the polymer-functionalized carbon nanotube according to the invention, the groups on the second polymer which are reactive towards amino groups include cyclic carboxylic acid anhydride groups and/or isocyanate groups. Preferred carboxylic acid anhydride groups are those with 5 or 6 ring atoms, an example being succinic anhydride groups. These functional groups are formed by the copolymerization of maleic anhydride with an olefin. The advantage of carboxylic acid anhydride groups is that their reaction with the amino groups on the first polymer does not involve the release of condensation products, but rather a ring opening. Isocyanate groups can be e.g. part of a polyurethane polymer, a polyurethane prepolymer or a polymeric polyisocyanate. The following, inter alia, are suitable: polyurethane polymers, polyurethane prepolymers or polymeric polyisocyanates based on aromatic or aliphatic polyisocyanates such as toluoylene diisocyanate, diphenyldimethane diisocyanate, hexamethylene diisocyanate, isophorone diisocyanate and/or H₁₂-diphenylmethane diisocyanate.

In another embodiment of the polymer-functionalized carbon nanotube according to the invention, the second polymer is selected from the group comprising poly(octadecene/maleic anhydride), poly(ethylene/maleic anhydride), poly(styrene/maleic anhydride), poly(isobutylene/maleic anhydride) and/or poly(methyl vinyl ether/maleic anhydride). These polymers combine the advantage of reactive cyclic carboxylic acid anhydride groups with the possibility of controlling the hydrophobicity of the secondary functionalization via the choice of olefin copolymerized with maleic anhydride. The molecular weight Mₙ of these polymers can be 20,000 g/mol to 100,000 g/mol, preferably 30,000 g/mol to 50,000 g/mol. Particular preference is afforded to a poly(octadecene/maleic anhydride) with a molecular weight Mₙ of 30,000 g/mol to 50,000 g/mol.

As regards the actual carbon nanotube to be functionalized, it can be e.g. a non-covalently functionalized, multiwalled carbon nanotube with a diameter of 3 nm to 100 nm, the diameter referring to the mean diameter of the nanotubes. It can also be in the range from 5 nm to 80 nm, advantageously from 6 nm to 60 nm. The length of the nanotubes is initially unlimited, but it can be e.g. in the range from 50 nm to 100 μM, advantageously from 100 nm to 10 μm. Such carbon nanotubes are available e.g. under the name BAYTUBES® from Bayer MaterialScience AG.

The present invention also provides a process for the production of a polymer-functionalized carbon nanotube according to the invention, comprising the following steps:
A) mixing carbon nanotubes with an aqueous solution of a first polymer containing amino groups in order to prepare an aqueous dispersion of the carbon nanotubes with the first polymer adsorbed thereon;
B) optionally removing the aqueous solvent and purifying the carbon nanotubes; and
C) adding a solution of a second polymer containing groups reactive towards amino groups to the dispersion obtained in step A) or to the carbon nanotubes obtained in step B), comprising the first polymer adsorbed thereon, and leaving the second polymer to react with the first polymer.

Step A) of the process according to the invention initially comprises the provision of carbon nanotubes as the starting material. Suitable nanotubes have already been described above, so they are fully incorporated herein by way of reference without being listed again. The same applies to the descriptions of the first and second polymers.

The carbon nanotubes are present in an aqueous solution of a first polymer containing amino groups. The concentration of the first polymer in the aqueous solution, calculated without the carbon nanotubes, can be e.g. in the range from 0.01 wt. % to 10 wt. %, preferably from 0.1 wt. % to 1 wt. %, based on the total weight of the aqueous solution without the carbon nanotubes. The concentration of the carbon nanotubes in question in the aqueous solution of the first polymer can be e.g. in the range from 0.1 wt. % to 10 wt. %, preferably from 1 wt. % to 5 wt. %, based on the total weight of the aqueous solution without the carbon nanotubes.

In step C) the resulting nanotubes primary functionalized with the first polymer are reacted with a solution of a second polymer in order to allow the amino groups on the first polymer to react with reactive groups on the second polymer. The solvent for the second polymer should keep the latter at least partially in solution with the desired proportions by weight. Advantageously, the second solvent is at least partially miscible with water so that the secondary functionalization can proceed in the homogeneous phase. In the case where the second polymer contains reactive groups which also react with water, the solvent should be inert or at least unreactive towards such groups, e.g. isocyanate groups. Examples of generally suitable solvents are methanol, ethanol, isopropanol, butanol, ethylene glycol, propylene glycol, butylene glycol, acetone, N,N-dimethylformamide, dimethyl sulfoxide, N-methyl-2-pyrrolidone, mixtures of the aforementioned solvents with one another and/or mixtures of the aforementioned solvents with water. Acetone is particularly preferred. The concentration of the second polymer in the solvent can be e.g. in the range from 0.01 wt. % to 10 wt. %, preferably from 0.1 wt. % to 1 wt. %.

In one embodiment of the process according to the invention, the carbon nanotubes obtained in step A), comprising the first polymer, are not dried before step C), i.e. the primary functionalized nanotubes obtained are not dried before they are reacted further. This is advantageous if the dried nanotubes from step A) tend to aggregate and then become unusable. However, step A) can definitely be followed by purification steps, e.g. washing and centrifugation. The carbon nanotubes obtained in step A), comprising the first polymer, can also be isolated in step B) after removal of the solvent and purification. Likewise, step C) can be followed by purification steps. After step C) the secondary functionalized carbon nanotubes can be dried, inter alia under vacuum.

In one embodiment of the process according to the invention, steps A) and/or C) are carried out at a temperature of 0° C. to 30° C. The process according to the invention has the advantage of not requiring high temperatures such as those prevailing e.g. in a reaction extrusion. Preferably, steps A) and/or C) are carried out at room temperature.

In another embodiment of the process according to the invention, the pH of the aqueous solution of the first polymer in step A) is >7. If the working medium is basic, the number of unprotonated amino groups can be increased. In this way, more amino groups are available for the secondary functionalization with the second polymer. The pH of the aqueous solution of the first polymer can be e.g. in the range from 8 to 10.

In another embodiment of the process according to the invention, the pH of the aqueous solution of the first polymer in step A) is <7. If the working medium is acidic, the number of unprotonated amino groups can be reduced. In this way, fewer amino groups are available for the secondary functionalization with the second polymer. The pH of the aqueous solution of the first polymer can be e.g. in the range from 2 to 6.5.

One advantage of the process according to the invention is that step A) is carried out in aqueous solution. This affords two possible ways of influencing the subsequent surface properties of the polymer-functionalized carbon nanotubes according to the invention. It is possible not only to choose the second polymer, but also to determine the extent to which the second polymer bonds to the first by fixing the pH.

The present invention also provides a dispersion comprising polymer-functionalized carbon nanotubes according to the invention. This utilizes the dispersibility of the nanotubes according to the invention. The dispersion medium can be liquid or solid. For example, it can be a polymer, especially a polyurethane, in which case there is a polyurethane polymer in which the carbon nanotubes according to the invention are dispersed.

In one preferred embodiment, the polymer-functionalized carbon nanotubes can be present in the dispersion according to the invention in a proportion of 0.1 wt. % to 15 wt. %. The proportion of these carbon nanotubes can also be 0.5 wt. % to 5 wt. %.

In one embodiment of the dispersion, it is a non-aqueous liquid dispersion. Examples of dispersants which can be used for this purpose are methanol, ethanol, isopropanol, butanol, ethylene glycol, propylene glycol, butylene glycol, acetone, N,N-dimethylformamide, dimethyl sulfoxide, N-methyl-2-pyrrolidone, mixtures of the aforementioned solvents with one another and/or mixtures of the aforementioned solvents with water. In one embodiment, acetone is preferred.

The nanotubes according to the invention can be prepared in this way for further processing, e.g. as coating agents.

Other embodiments are described below:
A polymer-functionalized carbon nanotube comprising a carbon nanotube, a first polymer containing amino groups which is adsorbed on the outer surface of the carbon nanotube, and a second polymer covalently bonded to the first polymer, the bonding of the second polymer to the first polymer being achieved by the reaction of amino groups on the first polymer with groups on the second polymer which are reactive towards amino groups.
The polymer-functionalized carbon nanotube can be characterized in that the amino groups on the first polymer containing them are primary amino groups.
In one embodiment the polymer-functionalized carbon nanotube is one in which the first polymer is selected from the group comprising polyvinylamine, polyallylamine, polyaminosaccharide, polyethyleneimine and/or copolymers of the aforementioned polymers with other polymers or comonomers, especially vinyl monomers.
The polymer-functionalized carbon nanotube can be characterized in that the groups on the second polymer which are reactive towards amino groups include cyclic carboxylic acid anhydride groups and/or isocyanate groups.
In one embodiment the polymer-functionalized carbon nanotube is one in which the second polymer is selected from the group comprising poly(octadecene/maleic anhydride), poly(ethylene/maleic anhydride), poly(styrene/maleic anhydride), poly(isobutylene/maleic anhydride) and/or poly(methyl vinyl ether/maleic anhydride).
In one embodiment the process for the production of a polymer-functionalized carbon nanotube comprises the following steps:
   (A) preparing carbon nanotubes in an aqueous solution of a first polymer containing amino groups; and
   (C) adding a solution of a second polymer containing groups reactive towards amino groups to a dispersion of the carbon nanotubes obtained in step (A), comprising the first polymer.
Optionally the carbon nanotubes obtained in step (A), comprising the first polymer, are not dried before step (C).
Optionally steps (A) and/or (C) are carried out at a temperature of ≧0° C. to ≦30° C.
Optionally the pH of the aqueous solution of the first polymer in step (A) is >7.
In another embodiment the pH of the aqueous solution of the first polymer in step (A) is <7.
Dispersions comprising the polymer-functionalized carbon nanotubes described above, especially non-aqueous liquid dispersions comprising the polymer-functionalized carbon nanotubes described above, are likewise embodiments.

The present invention also provides a polymer comprising polymer-functionalized carbon nanotubes according to the invention in a proportion below the percolation limit of the polymer-functionalized carbon nanotubes. The polymer can be e.g. a polyurethane. The percolation limit is to be understood here as meaning the content of carbon nanotubes according to the invention above which the electrical conductivity of the polymer comprising the nanotubes increases discontinuously. If the percolation limit is not exceeded, the dielectric constant of the material can be increased. This is how dielectric elastomers can be obtained with a suitable base polymer.

The present invention also provides a polymer comprising polymer-functionalized carbon nanotubes according to the invention in a proportion above the percolation limit of the polymer-functionalized carbon nanotubes. The polymer can be e.g. a polyurethane polymer. Above the percolation limit such materials can be used e.g. as electrodes or, with a suitable base polymer, as elastomeric electrodes.

The present invention also provides a surface coating comprising polymer-functionalized carbon nanotubes according to the invention. Preferably, carbon nanotubes hydrophobized by the secondary functionalization are used to obtain hydrophobic surface coatings. The nanotubes used in this case can have water contact angles of e.g. 145° to 175°, preferably of 155° to 170°, as determined by the Wilhelmy plate method. For a surface coating, the nanotubes can be incorporated into binders; inter alia, they can be incorporated into melamine resins, polyurethanes or silicones.

Addition of the polymer-functionalized carbon nanotubes according to the invention to a base polymer can increase the electrical conductivity and/or mechanical strength of the base polymer. It can also increase the electrical conductivity and/or mechanical strength of surface coatings.

The polymer-functionalized carbon nanotubes according to the invention are particularly suitable as an additive for increasing the electrical conductivity and/or mechanical strength of polymers or surface coatings.

Various other embodiments of the invention are polymers comprising the aforementioned polymer-functionalized carbon nanotubes in a proportion below the percolation limit of the polymer-functionalized carbon nanotubes, polymers comprising the aforementioned polymer-functionalized carbon nanotubes in a proportion above the percolation limit of the polymer-functionalized carbon nanotubes, and surface coatings comprising the aforementioned polymer-functionalized carbon nanotubes.

The present invention is illustrated in greater detail with the aid of the Figures below, in which:

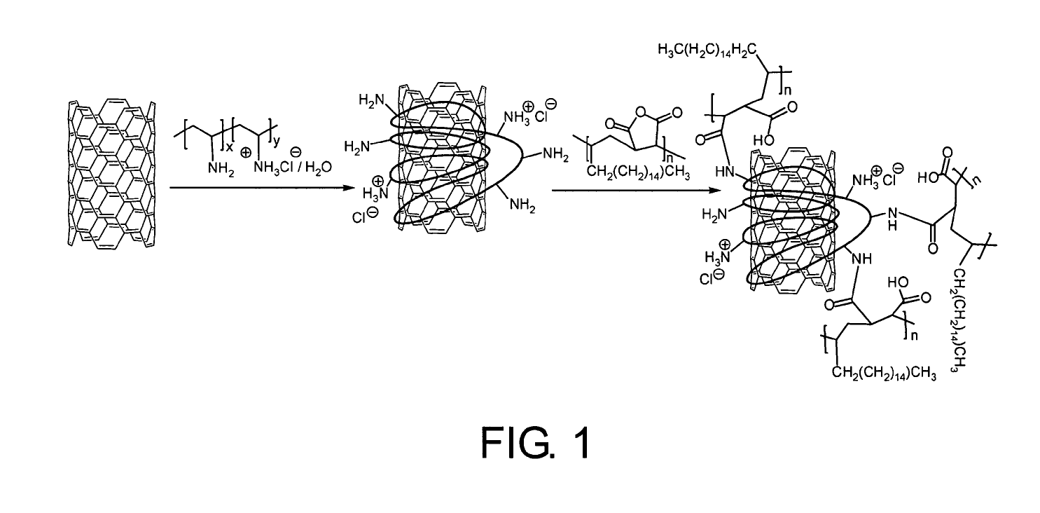

FIG. 1 shows the synthesis of functionalized carbon nanotubes according to the invention

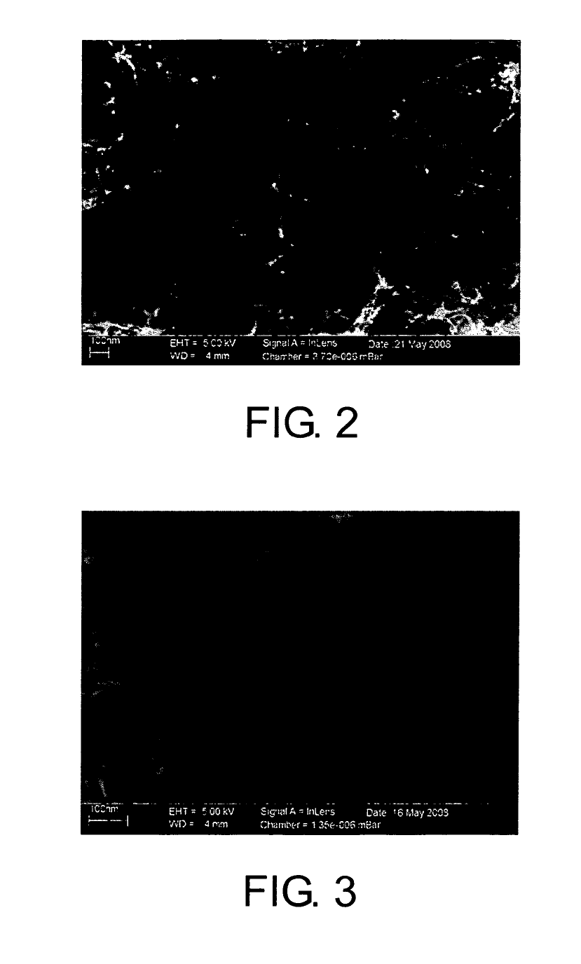

FIG. 2 shows a scanning electron micrograph of non-functionalized carbon nanotubes

FIG. 3 shows a scanning electron micrograph of functionalized carbon nanotubes according to the invention

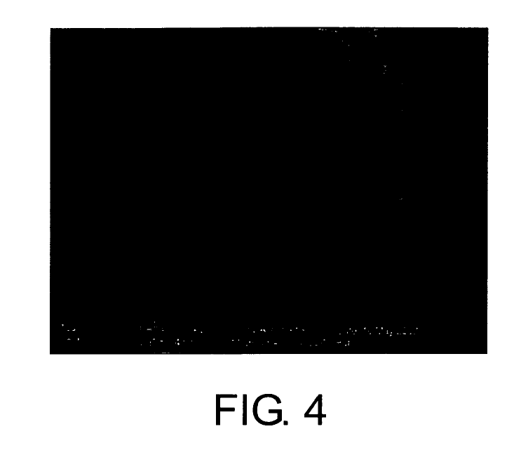

FIG. 4 shows a scanning electron micrograph of carbon nanotubes functionalized according to the invention

FIG. 1 schematically shows, by way of example, the synthesis of carbon nanotubes functionalized according to the invention. The carbon nanotube used as educt is first reacted with polyvinylamine. Depending on the pH of the aqueous polyvinylamine solution, a greater or lesser part of the polyvinylamine is present in protonated form. The Figure shows the protonated form as amine hydrochloride. The proportion of the unprotonated form of polyvinylamine is given by the variable x and the proportion of the protonated form is given by the variable y. This is a schematic representation and should not be understood as a block copolymer.

The product of the first reaction is the carbon nanotube with polyvinylamine/polyvinylamine hydrochloride wrapped around it. The polymer backbone and free amino and ammonium groups are shown. As described at the outset, only the free amino groups contribute, through non-covalent interactions, to the bonding of the polymer to the nanotube surface. By varying the pH of the aqueous polyvinylamine solution, it is thus possible to influence how the adsorption of the polyvinylamine proceeds. Furthermore, free amino groups can be blocked by protonation so that they do not participate in the following functionalization step.

The carbon nanotube with polyvinylamine/polyvinylamine hydrochloride wrapped around it is then reacted with poly(octadecene/maleic anhydride)—or, more simply, POMA—whereby maleic anhydride groups of the POMA react with free amino groups. This results in hydrophobic C₁₆-alkyl chains and carboxylic acid groups protruding from the surface of the secondary functionalized carbon nanotube. Expressly included according to the invention is the case where several maleic anhydride groups of a POMA polymer strand react with the amino groups present on a carbon nanotube.

FIG. 2 shows a scanning electron micrograph of non-functionalized carbon nanotubes. This micrograph serves as a reference for assessing the morphology of the functionalized nanotubes.

FIG. 3 shows a scanning electron micrograph of carbon nanotubes which were first functionalized with an aqueous polyvinylamine solution at a pH of 6.5 and then reacted further with poly(octadecene/maleic anhydride). A comparison with the micrograph of FIG. 2 shows that the morphology of the nanotubes was maintained after the secondary functionalization.

FIG. 4 shows a scanning electron micrograph of carbon nanotubes which were first functionalized with an aqueous polyvinylamine solution at a pH of 8 and then reacted further with poly(octadecene/maleic anhydride). A comparison with the micrograph of FIG. 2 shows that the morphology of the nanotubes was maintained after the secondary functionalization.

The present invention is also illustrated in greater detail with the aid of the Examples below.

### EXAMPLES

### Example Group 1 comprising Examples 1a, 1b and 1c

0.5 g of BAYTUBES® (multiwalled carbon nanotubes, Bayer MaterialScience AG) was weighed into a Teflon centrifuge tube and 20 ml of a polyvinylamine solution (PVAm 9095, M_{w}=340,000 g/mol, degree of hydrolysis >90%, BASF SE; 1 wt. % solution in water) of appropriate pH were added. The pH was 6.5 in Example 1a, 8 in Example 1b and 11 in Example 1c. This reaction mixture was shaken continuously for 30 minutes and then centrifuged for 30 minutes at 12,000 rpm to separate the nanotubes from the polymer solution. The modified nanotubes were then washed with twice 20 ml of distilled water and centrifuged again to separate them off. The modified nanotubes were then washed with twice 20 ml of acetone. 0.2 g of poly(octadecene/maleic anhydride) (POMA, Mₙ=30,000 to 50,000 g/mol, Aldrich) was dissolved in 30 ml of acetone and then added to the nanotubes carrying amino groups, in a centrifuge tube. The reaction mixture was shaken constantly for two hours at room temperature and then centrifuged for 30 minutes at 12,000 rpm. The sample was extracted with acetone for three days in order to rinse excess non-functionalized copolymer from the surface. The modified nanotubes were then dried under vacuum at room temperature. It was observed that the nanotubes modified in this way remained flowable after both the first and the second functionalization.

### Example Group 2 comprising Examples 2a to 2f

0.5 g of multiwalled carbon nanotubes (NANOCYL 7000 series, Nanocyl S.A.) was weighed into a Teflon centrifuge tube and 20 ml of a polyvinylamine solution (PVAm 9095, M_{w}=340,000 g/mol, degree of hydrolysis >90%, BASF SE; 1 wt. % solution in water) of appropriate pH were added. The pH was 2 in Example 2a, 3 in Example 2b, 4.2 in Example 2c, 6.5 in Example 2d, 8 in Example 2e and 11 in Example 2f. This reaction mixture was shaken continuously for 30 minutes and then centrifuged for 60 minutes at 12,000 rpm to separate the nanotubes from the polymer solution. The modified nanotubes were then washed with twice 20 ml of distilled water and centrifuged again to separate them off. The modified nanotubes were then washed with twice 20 ml of acetone. 0.2 g of poly(octadecene/maleic anhydride) (POMA, Mₙ=30,000 to 50,000 g/mol, Aldrich) was dissolved in 30 ml of acetone and then added to the nanotubes carrying amino groups, in a centrifuge tube. The reaction mixture was shaken constantly for two hours at room temperature and then centrifuged for 30 minutes at 12,000 rpm. The sample was extracted with acetone for three days in order to rinse excess non-functionalized copolymer from the surface. The modified nanotubes were then dried under vacuum at room temperature. It was observed that the nanotubes modified in this way remained flowable after the second functionalization.

The functionalized carbon nanotubes obtained in Example Group 2 were characterized by elemental analysis (C, H, N) and measurement of the contact angle. The results of the measurements are reproduced in the Table below. The results in brackets for the determination of the contact angle and the N content in the elemental analysis are the measured values for the intermediate in the preparation, on which only the polyvinylamine is adsorbed.

| | | Elemental | Elemental | Elemental |
|---|---|---|---|---|
| | Contact angle | analysis | analysis | analysis |
| Example | θ [°] | C [%] | H [%] | N [%] |
| Starting material | 146.3 ± 6.9 | 87.77 | 0.52 | — |
| Nanotubes | | | | |
| 2a (pH 2) | 164.9 ± 13.5 | 76.24 | 3.40 | 3.08 (3.49) |
| | (122.9 ± 0.2) | | | |
| 2b (pH 3) | 166.3 ± 12.1 | 76.88 | 3.43 | 2.96 (3.42) |
| | (131.1 ± 1.3) | | | |
| 2c (pH 4.2) | 148.5 ± 9.9 | 87.82 | 1.15 | 2.44 (3.38) |
| | (134.3 ± 12.4) | | | |
| 2d (pH 6.5) | 158.8 ± 18.8 | 82.89 | 2.38 | 2.66 (3.46) |
| | (145.4 ± 8.1) | | | |
| 2e (pH 8) | 170.0 ± 4.2 | 77.91 | 3.68 | 2.56 (3.28) |
| | (115.9 ± 25.4) | | | |
| 2f (pH 11) | 147.02 ± 3.1 | 79.35 | 3.76 | 3.05 (3.58) |
| | (126.6 ± 3.2) | | | |

The contact angle was determined by the Wilhelmy plate method using a Dataphysics DCAT 11 dynamic contact angle meter and tensiometer for the software-controlled determination of the contact angle of powders. The coated carbon nanotubes were attached to a 1×1 cm piece of double-sided adhesive tape from Tesa AG. The nanotubes completely covered this adhesive tape. The coated adhesive tape was then dipped in deionized water and pulled out, making it possible to measure the resulting force consisting of gravitational force (F_{G}), negligible lifting force (F_{A}) and Wilhelmy or wetting force (F_{W}). With the wetting force, the contact angle θ can be calculated by means of the following equation: cos(θ)=F_{W}/(u·γₗᵥ), where u is the perimeter of the adhesive tape and γₗᵥ is the surface tension of water at 23° C. (γₗᵥ=72.8 mN·m⁻¹).

The results of the contact angle measurement show a distinct hydrophobization of the carbon nanotubes after the secondary functionalization.

1.-14. (canceled)

15. A polymer-functionalized carbon nanotube comprising a carbon nanotube, a coupling product of a first polymer containing amino groups with a second polymer covalently bonded to the first polymer, wherein said coupling product is adsorbed on the outer surface of the carbon nanotube, and wherein the second polymer is bonded to the first polymer by the reaction of amino groups on the first polymer with groups on the second polymer which are reactive towards amino groups.

16. The polymer-functionalized carbon nanotube according to claim 15, wherein the amino groups on the first polymer comprise primary amino groups.

17. The polymer-functionalized carbon nanotube according to claim 15, wherein the first polymer comprises polyvinylamine, polyallylamine, polyaminosaccharide, polyethyleneimine and/or copolymers based on the aforementioned polymers with other comonomers, or mixtures thereof.

18. The polymer-functionalized carbon nanotube according to claim 15, wherein the groups on the second polymer which are reactive towards amino groups comprise cyclic carboxylic acid anhydride groups and/or isocyanate groups.

19. The polymer-functionalized carbon nanotube according to claim 18, wherein the second polymer comprises poly(octadecene/maleic anhydride), poly(ethylene/maleic anhydride), poly(styrene/maleic anhydride), poly(isobutylene/maleic anhydride), poly(methyl vinyl ether/maleic anhydride), or mixtures thereof.

20. A process for the production of the polymer-functionalized carbon nanotube according to claim 15, comprising the following steps:
A) mixing the carbon nanotube with an aqueous solution of the first polymer containing amino groups in order to prepare an aqueous dispersion of the carbon nanotubes with the first polymer adsorbed thereon;
B) optionally removing the aqueous solvent and purifying the carbon nanotubes; and
C) adding a solution of the second polymer comprising groups reactive towards amino groups to the dispersion obtained in step A) or to the carbon nanotubes obtained in step B), wherein the second polymer reacts with the first polymer.

21. The process according to claim 20 wherein the carbon nanotube obtained in step A), are isolated in step B) after removal of the solvent and purification.

22. The process according to claim 20 wherein steps A) and/or B) are carried out at a temperature in the range of from 0° C. to 30° C.

23. A polymer-functionalized carbon nanotube obtained by the process according to claim 20.

24. A dispersion comprising the polymer-functionalized carbon nanotube according to claim 15 and a dispersant.

25. The dispersion according to claim 24 wherein the dispersion is a non-aqueous liquid dispersion.

26. The dispersion according to claim 25, wherein the dispersant comprises acetone.

27. A polymer composition comprising a base polymer and the polymer-functionalized carbon nanotube according to claim 15 as an additive for increasing the electrical conductivity and/or mechanical strength of the base polymer.

28. A surface coating comprising a binder and the polymer-functionalized carbon nanotube according to claim 15 as an additive for increasing the electrical conductivity and/or mechanical strength of the coating.

29. An additive for increasing the electrical conductivity and/or mechanical strength of polymers or surface coatings, wherein the additive comprises the polymer-functionalized carbon nanotube according to claim 15.
